(19) United States
(12) Patent Application Publication
(10) Pub. No.: US 2012/0236914 A1
(43) Pub. Date: Sep. 20, 2012

(54) In-Band Modem Signals for Use on a Cellular Telephone Voice Channel

(76) Inventor: Gerhard Wessels, Ebersberg (DE)

(21) Appl. No.: 13/392,483

(22) PCT Filed: Aug. 26, 2009
(86) PCT No.: PCT/EP09/06193

§ 371 Date: May 8, 2012

(51) Int. Cl. G10L 19/02; H04B 1/38

(52) U.S. Cl. 375/222; 704/201; 704/E19.008

(57) ABSTRACT

Methods and systems for communicating data on a cellular telephone voice channel are disclosed. The method includes segmenting a data stream into one or more n-bit symbols; identifying a human vocal sound corresponding to each n-bit symbol according to a predetermined assignment of each n-bit symbol to a human vocal sound; and retrieving data representing the human vocal sound, wherein data representing the human vocal sound is configured to be passed through a vocoder.

### CROSS REFERENCE TO RELATED APPLICATIONS

This is a U.S. national stage of Application No. PCT/EP2009/006193, filed on 26 Aug. 2009.

### BACKGROUND OF THE INVENTION

### 1. Field of the Invention

This invention relates generally to cellular telephone Communications. More particularly, the invention relates to using a cellular telephone voice channel for in-band modem signals.

### SUMMARY

Disclosed is a method for communicating data on a cellular telephone voice channel, comprising: segmenting a data stream into one or more n-bit symbols; identifying a human vocal sound corresponding to each n-bit symbol according to a predetermined assignment of each n-bit symbol to a human vocal sound; and retrieving data representing the human vocal sound, wherein data representing the human vocal sound is configured to be passed through a vocoder.

Disclosed is a method for communicating data on a cellular telephone voice channel, comprising: decoding, from a cellular telephone voice signal, data representing one or more human vocal sounds, wherein each of the one or more human vocal sounds corresponds to an n-bit symbol according to a predetermined assignment of each n-bit symbol to each human vocal sound, wherein the data representing the human vocal sound is configured to be passed through a voice decoder; and identifying each n-bit symbol corresponding to each human vocal sound.

Disclosed is an apparatus, comprising: an in-band modem configured to segment a data stream into one or more n-bit symbols; and a data store operably coupled to the in-band modem, the data store configured to store a predetermined assignment of the n-bit symbol to a human vocal sound, wherein data representing the human vocal sound is configured to be passed through at least one of a vocoder and a voice decoder.

Disclosed is a system, comprising: a processor; a memory operably coupled to the processor; an in-band modem configured to segment a data stream into one or more n-bit symbols; and a data store operably coupled to the in-band modem, the data store configured to store a predetermined assignment of the n-bit symbol to a human vocal sound, wherein the human vocal sound is configured to be passed through at least one of a vocoder and a voice decoder.

Numerous additional embodiments are also possible. In one or more various aspects, related articles, systems, and devices include but are not limited to circuitry, programming, electro-mechanical devices, or optical devices for effecting the herein referenced method aspects; the circuitry, programming, electro-mechanical devices, or optical devices can be virtually any combination of hardware, software, and firmware configured to effect the herein referenced method aspects depending upon the design choices of the system designer skilled in the art.

The foregoing is a summary and thus contains, by necessity, simplifications, generalizations and omissions of detail; consequently, those skilled in the art will appreciate that the summary is illustrative only and is not intended to be in any way limiting. Other aspects, features, and advantages of the devices, processes, or other subject matter described herein will become apparent in the teachings set forth herein.

In addition to the foregoing, various other method, device, and system aspects are set forth and described in the teachings such as the text (e.g., claims or detailed description) or drawings of the present disclosure.

### BRIEF DESCRIPTION OF THE DRAWINGS

Other aspects and advantages of the invention may become apparent upon reading the detailed description and upon reference to the accompanying drawings.

FIG. 1A is a block diagram of an apparatus for communicating with an in-band modem signal on a cellular telephone voice channel;

FIG. 1B is a block diagram of another apparatus for communicating with an in-band modem signal on a cellular telephone voice channel;

FIG. 2 is a block diagram of a system for communicating with an in-band modem signal on a cellular telephone vocal channel is shown;

FIG. 3 is a flow chart of a method for communicating data on a cellular telephone voice channel;

FIG. 4 is a flow chart of a method for communicating data on a cellular telephone voice channel;

FIG. 5 is a flow chart of a method for communicating data on a cellular telephone voice channel; and

FIG. 6 is a flow chart of a method for communicating data on a cellular telephone voice channel.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### DETAILED DESCRIPTION

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the terms “couple,” “couples,” “coupled,” or “coupleable” are intended to mean either an indirect or direct electrical or wireless connection. Thus, if a first device is coupled to a second device, that connection may be through a direct electrical, optical, wireless connection, etc. or through an indirect electrical, optical, wireless connection, etc. by other devices and connections.

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art. Other embodiments may be utilized, and other changes may be made, without departing from the spirit or scope of the subject matter presented here.

Voice channels used by cellular telephones typically use data compression techniques based on specific properties of the human voice. For example, a Global System for Mobile Communication (“GSM”) codec may use a parameterized model of the human vocal tract to encode a voice signal. One example of an encoding technique using parameterization is linear predictive coding (herein, “LPC”). Using LPC, a coded voice is represented by the parameters of the human vocal tract model, a representation of an excitation signal (e.g., a value in a look-up table), and a representation of an error signal. Any non-voice signal is considered to be noise and is suppressed as much as possible. If one wishes to send data that represents something other than one or more human voices on a cellular telephone voice channel for which human voice parameterization is used, such data may be represented by signals that a cellular system codec will not be able to distinguish from a human voice. Such data might include location data or automotive performance data to be sent using the voice channel of an automotive on-board communications, tracking, and service system such as ONSTAR®.

In one embodiment of the present invention, sounds in various languages such as English, German, or French may be used to represent a number of bits of a data stream to be sent or received using a cellular telephone voice channel. Four sounds may code two bits, e.g.:
SOUND 1=00,
SOUND 2=01,
SOUND 3=10, and
SOUND 4=11.

Eight sounds may code three bits, e.g.:
SOUND 1=000,
SOUND 2=001,
SOUND 3=010,
SOUND 4=011,
SOUND 5=100,
SOUND 6=101,
SOUND 7=110, and
SOUND 8=111.

Similarly, more than eight sounds may be used to encode more than three bits (e.g., sixteen sounds to code four bits, and, in general, 2n sounds to code n bits.

In one embodiment of the invention, the model of the human vocal tract used to encode a voice signal is used to create signals that have the maximum possible Hamming distance when encoded. For a given vocoder (a voice coder or a voice coder section of a voice encoder/decoder), the output representation in bits of an input human vocal sound is known in advance (e.g., the index of an excitation signal in a look-up table). Human vocal sounds maybe selected for assignment to n-bit symbols such that the Hamming distance between the vocoder output bit representations are maximized, reducing the possibility of errors when the vocoder output bit representations are decoded by a decoder. In terms of the example herein in which eight sounds code three bits, the human vocal sounds SOUND 1 through SOUND 8 may be selected such that Hamming distances between the vocoder output bit representations of SOUND 1 through SOUND 8 are maximized.

In one embodiment of the invention, the model of the human vocal tract used to encode a voice signal is used to create data representing a human vocal sound such that the error signal is zero. For example, data representing a human vocal sound and configured to be passed through a vocoder may be created by exciting a model of the human vocal tract substantially similar (preferably, identical) to the human vocal tract model used by the particular vocoder to be used by an embodiment of the invention. The model may be excited by an excitation signal such as a signal from a look-up table. When such data is passed through such a vocoder, the error rate is zero and the signal may be reconstructed in a decoder without a loss of information. This increases the recognition reliability of an in-band modem of embodiments of the invention because the in-band modem will be able to more reliably recognize the decoded human vocal sound and identify an n-bit symbol corresponding to that human vocal sound. In terms of the example herein in which eight sounds code three bits, the data representing the human vocal sound SOUND 3, for example, may be created by exciting a human vocal tract model substantially similar or identical to the model used by the vocoder to be used by an embodiment of the invention. The model may be excited by an excitation signal such as a signal from a look-up table containing signals corresponding to various sounds including SOUND 3. When the data representing SOUND 3, created by excitation of the model by a signal corresponding to SOUND 3, is passed through the vocoder, the error rate is zero and SOUND 3 may be reconstructed in a decoder without loss of information.

Embodiments of the invention may use vowel sounds, consonant sounds, or other sounds included in human voice parameterization used in cellular voice channels. Embodiments of the invention are not limited to using sounds of only one language, e.g., embodiments may use sounds selected from English or German or both. Further, embodiments are not limited to the exemplary languages mentioned herein. Embodiments of the invention may also use any sound, whether associated with human vocalization or not, that would not be reduced or eliminated as noise by hardware, software, or firmware implementing a voice communication system. Embodiments of the invention may also be used in conjunction with voice communication systems other than cellular telephony, including but not limited to voice-over-internet-protocol (“VoIP”) systems.

Typically, the base period of a vowel, for instance, is approximately 10 milliseconds (ms). The typical base period of a GSM codec symbol is approximately 20 ms. A data stream may be coded as a sequence of 3-bit GSM codec symbols using eight vowels, where the data stream may be transmitted over a GSM cellular telephone voice channel as a series of 20-ms-long symbols, each symbol representing a vowel sound. More than one base period of a single vowel may be concatenated to construct one codec symbol. With a symbol duration of 20 ms and three bits per symbol without error correction, this method yields a symbol rate of 50 baud and a bit rate of 150 bits/second. Skilled artisans will recognize that the embodiments described herein are not limited to GSM implementations.

Turning now to Figure IA, an apparatus for communicating with an in-band modem signal on a cellular telephone voice channel is shown. The exemplary apparatus 100 includes a data source 102, an in-band modem 104, a data store 106, a vocoder 108, and a cellular telephone transceiver 110. Data to be communicated over a cellular telephone voice channel may originate in the data source 102 and is communicated to the in-band modem 104. The in-band modem may be used to segment the data stream into n-bit symbols, e.g., 3-bit symbols. The data store 106 stores the assignments of human vocal sounds to n-bit symbols, e.g., eight vowel sounds to eight 3-bit symbols. The data store 106 may store the assignments in a look-up table, but the invention are not limited to look-up tables. These assignments are made available to the in-band modem 104, which uses the assignments to code the symbols as human vocal sounds, e.g., vowels. The in-band modem 104 sends data signifying the human vocal sounds, in the form of segments approximately 20 ms in duration, to the vocoder 108. The vocoder 108 sends digital representations of the human vocal sounds to the cellular telephone transceiver 110. The cellular telephone transceiver 110 transmits a signal including the human vocal sounds corresponding to the n-bit symbols representing the data to be communicated, e.g., vowels corresponding to 3-bit symbols.

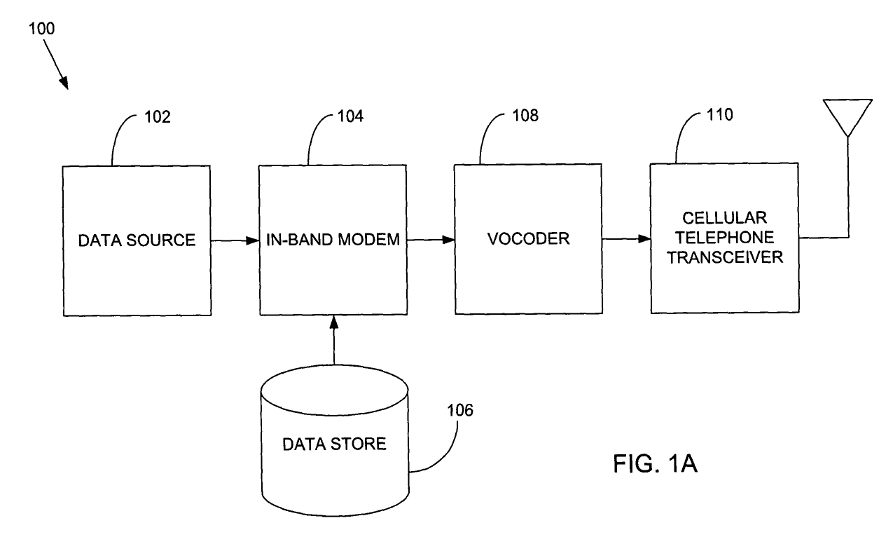

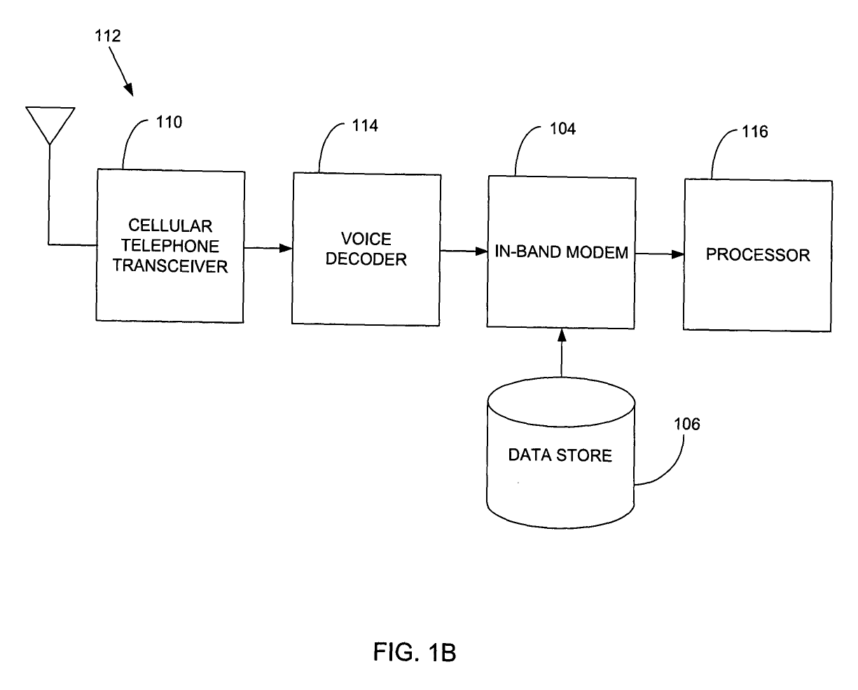

Turning now to Figure IB another apparatus for communicating with an in-band modem signal on a cellular telephone voice channel is shown. The exemplary apparatus 112 includes a cellular telephone transceiver 110, a voice decoder 114, an in-band modem 104, a data store 106, and a processor 116. Data to be communicated is included in a signal including human vocal sounds corresponding to the n-bit symbols, such as the signal transmitted in connection with FIG. 1. The signal is received by the cellular telephone transceiver 110. The signal is provided to the voice decoder 114. The voice decoder 114 may be used to detect and decode the received digital representations of human vocal sounds to obtain data signifying human vocal sounds, e.g., segments approximately 20 ms in duration signifying vowel sounds, to the in-band modem 104. The decoding may be accomplished using standard pattern comparison methods that are known in the art, such as autocorrelation. Using assignments of human vocal sounds to n-bit symbols stored in the data store 106, the in-band modem 104 converts the human vocal sounds to n-bit symbols. For instance, where eight vowels are used to code eight 3-bit symbols, the in-band modem 106 converts the vowel segments into 3-bit symbols. The n-bit symbols, representing the data sent over the voice channel, may be sent to a processor 116, or to some other device.

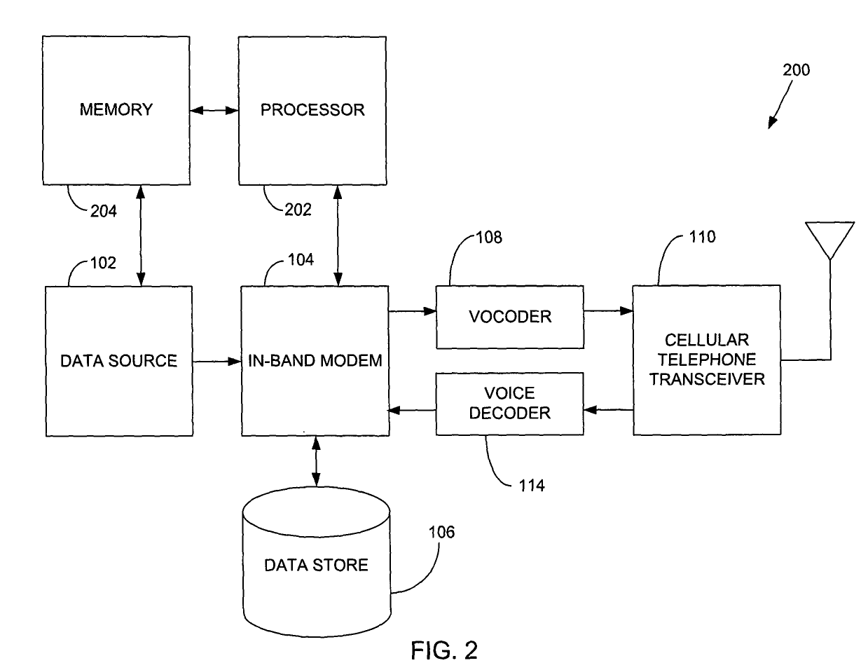

Turning now to FIG. 2, a system for communicating with an in-band modem signal on a cellular telephone vocal channel is shown. The exemplary system 200 includes a processor 202, a memory 204, a data source 102, an in-band modem 104, a data store 106, a vocoder 108, a voice decoder 114, and a cellular telephone transceiver 110. The processor 202 may be the same processor as processor 116 of Figure IB but need not be. Similarly, the memory 204 may be the same memory resource as the data store 106 but need not be. The exemplary system 200 may be configured as, for example, a cellular telephone, an automotive communications system, a desktop computer, a laptop computer, or a personal digital assistant. Those skilled in the art will recognize that while the system 200 may be configured as one of the items in the exemplary list, it is not limited to those items. Those skilled in the art will also recognize that system configurations including the processor 202 and the memory 204 are not limited to the configuration illustrated in FIG. 2.

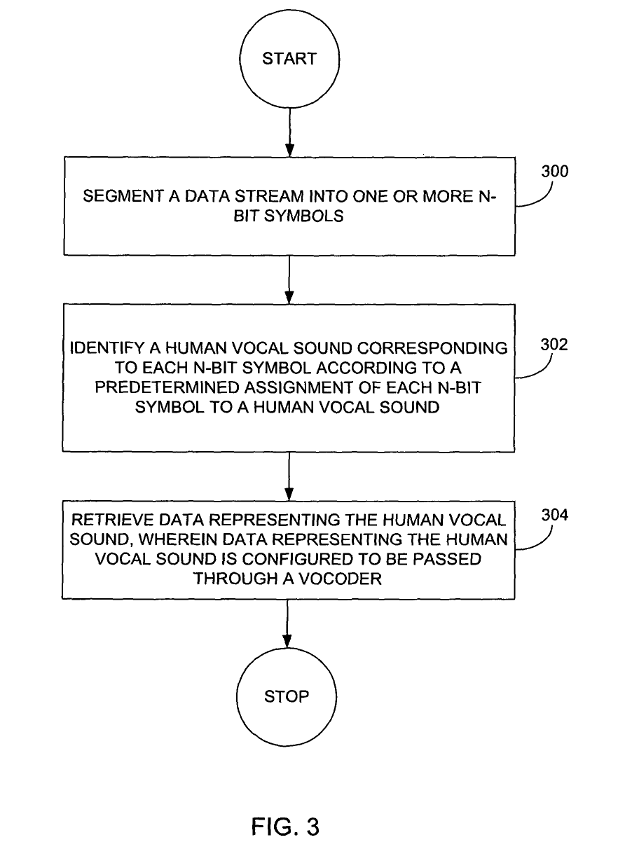

Turning now to FIG. 3, a flow chart of a method for communicating data on a cellular telephone voice channel is shown. The embodiment illustrated may include one or more of the following operations: 300, 302, and 304.

Operation 300 includes segmenting a data stream into one or more n-bit symbols. Referring to the apparatus 100 of Figure IA, operation 300 may include segmenting a data stream from the data source 102 with the in-band modem 106 into one or more n-bit symbols. For example, the data stream may be segmented into 3-bit symbols, including a symbol such as 011.

Operation 302 includes identifying a human vocal sound corresponding to each n-bit symbol according to a predetermined assignment of each n-bit symbol to a human vocal sound. Continuing the example of operation 300 using the apparatus 100 of FIG. 1A, operation 302 may include identifying a human vocal sound corresponding to an n-bit symbol according to a predetermined assignment of the n-bit symbol to a human vocal sound. The predetermined assignment may be stored in the data store 106 and the identification may be performed using the in-band modem 104. In this example, the predetermined assignment may include assignment of the human vocal sound of the German vowel “u” to the 3-bit symbol 011.

Operation 304 includes retrieving data representing the human vocal sound, wherein data representing the human vocal sound is configured to be passed through a vocoder. Continuing the example of operations 300 and 302, operation 304 may include retrieving data representing the German vowel “u” from the data store 106 or from some other memory resource. The data representing the German vowel “ü” is configured to be passed through a vocoder such as the vocoder 108. The data representing the German vowel “ü” may include a parameterization of the sound based on a model of the human vocal tract, such as the vocal tract model used in conjunction with GSM.

With reference to maximizing the Hamming distance between vocoder output bit representations of human vocal sounds as described herein, the predetermined assignment of each n-bit symbol to a human vocal sound of operation 302 may include a selection of the human vocal sound to maximize a Hamming distance between a first vocoder output bit representation of the human vocal sound and a second vocoder output bit representation of another human voice sound to which another of the n-bit symbols is assigned. For example, given known vocoder output bit representations for human vocal sounds for the vocoder 108 of operation 304, the predetermined assignment of operation 302 may include a selection of human vocal sounds to maximize the Hamming distance between the output bit representations from vocoder 108 for those human vocal sounds.

With reference to constructing symbol such that the error signal is zero as described herein, operation 304 includes retrieving such data, wherein the data representing the human vocal sound is created using a human vocal tract model that is substantially similar to a human vocal tract model used by the vocoder. For example, the data representing the human vocal sound may be created using a human vocal tract model that is substantially similar to a human vocal tract model used by the vocoder 108.

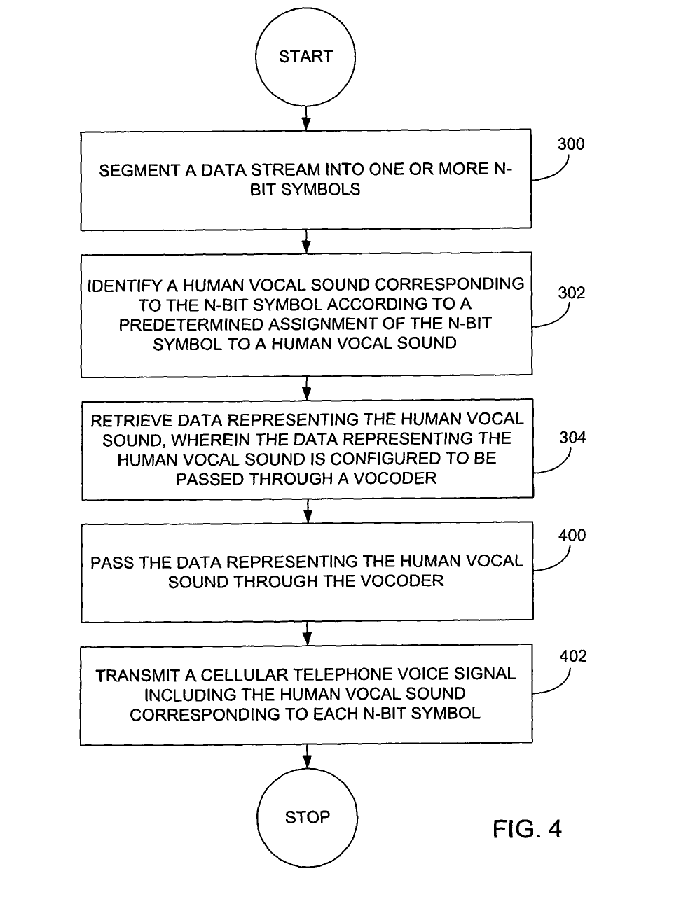

Turning now to FIG. 4, a flow chart of another method for communicating data on a cellular telephone voice channel is shown. The embodiment illustrated may include one or more of the following operations: 300 (described above), 302 (described above), 304 (described above), 400, and 402.

Operation 400 includes passing the data representing the human vocal sound through the vocoder. Continuing the example begun in connection with operation 300 and continued in connection with operations 300, 302, and 304, the data representing a human vocal sound, such as a parameterization of the German vowel “ü” may be passed through the vocoder 108. The vocoder 108 may send a digital representation of the human vocal sound to the cellular telephone transceiver 110 for transmission on a cellular telephone voice channel.

Operation 402 includes transmitting a cellular telephone voice signal including the human vocal sound corresponding to each n-bit symbol. Continuing the example of operation 400, the cellular telephone transceiver 110 may transmit a cellular telephone voice signal including the human vocal sound corresponding to the n-bit symbol. In this example, the cellular telephone voice signal may include an approximately 20-ms-long German vowel “ü” sound.

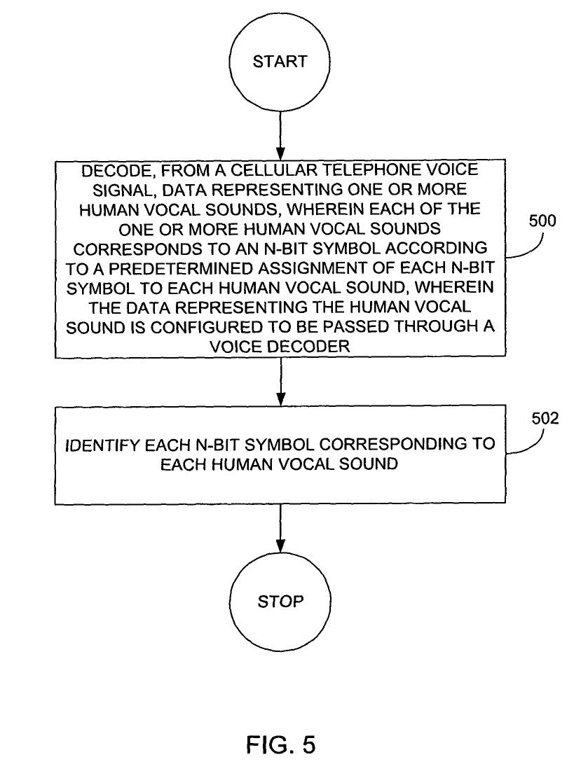

Turning now to FIG. 5, a flow chart of another method for communicating data on a cellular telephone voice channel is shown. The embodiment illustrated includes one or more of the following operations: 500 and 502.

Operation 500 includes decoding, from a cellular telephone voice signal, data representing one or more human vocal sounds, wherein each of the one or more human vocal sounds corresponds to an n-bit symbol according to a predetermined assignment of each n-bit symbol to each human vocal sound, wherein the data representing the human vocal sound is configured to be passed through a voice decoder. Referring to the apparatus 112 of FIG. 1, a cellular telephone voice signal may be provided to the voice decoder 114, which decodes a human vocal sound that corresponds to an n-bit symbol according to a predetermined assignment of the n-bit symbol to the human vocal sound, here a German vowel “ü.”

Operation 502 includes identifying each n-bit symbol corresponding to each human vocal sound. Continuing the example used in connection with operation 500, the human vocal sound may be passed to the in-band modem 104. The in-band modem 104 may-identify the n-bit symbol that corresponds to the human vocal sound according to the predetermined assignment. The predetermined assignment may be stored in a data store 106 and made available to the in-band modem 104. Here, for example, the symbol Oil corresponds to the German vowel “ü” according to the predetermined assignment.

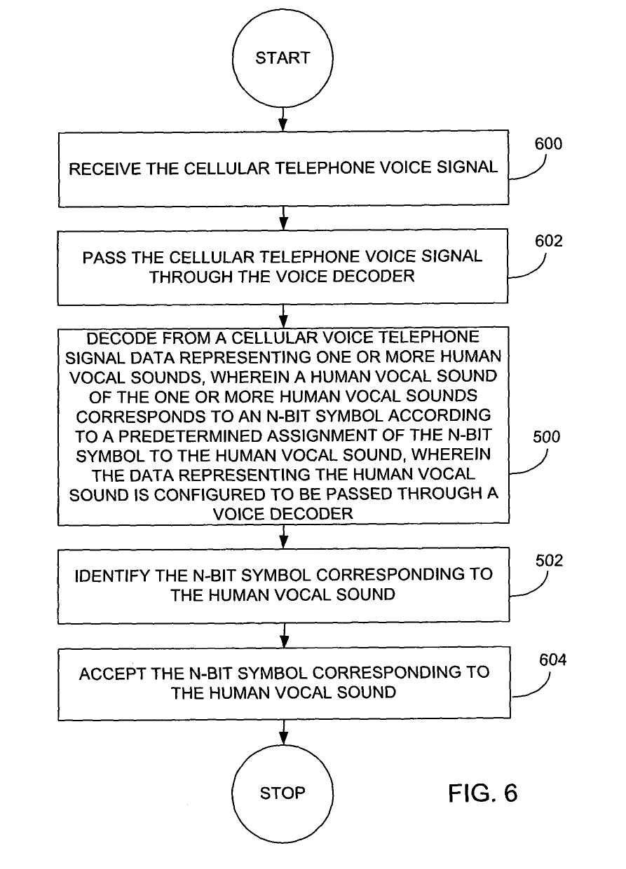

Turning now to FIG. 6, a flow chart of another method for communicating data on a cellular telephone voice channel is shown. The embodiment illustrated may include one or more of the following operations: 500 (described above), 502 (described above), 600, 602, and 604.

Operation 600 may include receiving the cellular telephone voice signal. Continuing the example begun in connection with operation 500 and continued in connection with operation 502, the cellular telephone voice signal that includes the German vowel “u” in a 20-ms segment may be received by the cellular telephone transceiver 110.

Operation 602 includes passing the cellular telephone voice signal through the voice decoder. Continuing the example used in connection with operation 600, the cellular telephone voice signal may be passed through the voice decoder 114. Specifically, the signal including the German vowel “ü” may be passed through the voice decoder 114 so that it may be decoded.

Operation 604 includes accepting the n-bit symbol corresponding to the human vocal sound. Continuing the example used in connection with operation 502, a processor such as the processor 202 of FIG. 2 may accept the n-bit symbol corresponding to the human vocal sound according to a predetermined assignment, in this example, the symbol 011 corresponding to the German vowel “ü.”

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein. The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with respect to a limited number of embodiments, those skilled in the art will appreciate numerous modifications and variations therefrom. It is intended that the appended claims cover all such modifications and variations as fall within the true spirit and scope of this present invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-26. (canceled)

27. A method for communicating data on a cellular telephone voice channel, comprising:
segmenting a data stream into one or more n-bit symbols;
identifying a human vocal sound corresponding to each n-bit symbol according to a predetermined assignment of each n-bit symbol to a human vocal sound; and
retrieving data representing the human vocal sound,
wherein data representing the human vocal sound is configured to be passed through a vocoder.

28. The method of claim 27, further comprising: passing the data representing the human vocal sound through the vocoder.

29. The method of claim 27, further comprising: transmitting a cellular telephone voice signal including the human vocal sound corresponding to each n-bit symbol.

30. The method of claim 27, further comprising:
decoding, from a cellular telephone voice signal, data representing one or more human vocal sounds, wherein each of the one or more human vocal sounds corresponds to an n-bit symbol according to a predetermined assignment of each n-bit symbol to each human vocal sound, wherein the data representing the human vocal sound is configured to be passed through a voice decoder; and
identifying each n-bit symbol corresponding to each human vocal sound.

31. The method of claim 30, further comprising: accepting the n-bit symbol corresponding to the human vocal sound.

32. The method of claim 30, further comprising: receiving the cellular telephone voice signal.

33. The method of claim 30, further comprising: passing the cellular telephone voice signal through the voice decoder.

34. The method of claim 27, wherein the human vocal sound includes at least one of a human vowel sound and a human consonant sound.

35. The method of claim 27, wherein the predetermined assignment of each n-bit symbol to a human vocal sound includes a selection of the human vocal sound to maximize a Hamming distance between a first vocoder output bit representation of the human vocal sound and a second vocoder output bit representation of another human voice sound to which another of the n-bit symbols is assigned.

36. The method of claim 27, wherein the data representing the human vocal sound is created using a human vocal tract model that is substantially similar to a human vocal tract model used by the vocoder.

37. A method for communicating data on a cellular telephone voice channel, comprising:
decoding, from a cellular telephone voice signal, data representing one or more human vocal sounds, wherein each of the one or more human vocal sounds corresponds to an n-bit symbol according to a predetermined assignment of each n-bit symbol to each human vocal sound, wherein the data representing the human vocal sound is configured to be passed through a voice decoder; and
identifying each n-bit symbol corresponding to each human vocal sound.

38. The method of claim 37, further comprising: accepting the n-bit symbol corresponding to the human vocal sound.

39. The method of claim 37, further comprising: receiving the cellular telephone voice signal.

40. The method of claim 37, further comprising: passing the cellular telephone voice signal through the voice decoder.

41. The method of claim 37, further comprising:
segmenting a data stream into one or more n-bit symbols;
identifying the human vocal sound corresponding to each n-bit symbol according to the predetermined assignment of each n-bit symbol to the human vocal sound;
retrieving data representing the human vocal sound, wherein the data representing the human vocal sound is configured to be passed through a vocoder; and
passing the data representing the human vocal sound through the vocoder.

42. The method of claim 41, further comprising: transmitting the cellular telephone voice signal including the human vocal sound corresponding to each n-bit symbol.

43. The method of claim 41, wherein the human vocal sound includes at least one of a human vowel sound and a human consonant sound.

44. An apparatus, comprising:
an in-band modem configured to segment a data stream into one or more n-bit symbols; and
a data store operably coupled to the in-band modem, the data store configured to store a predetermined assignment of each of the one or more n-bit symbols to a human vocal sound,
wherein data representing the human vocal sound is configured to be passed through at least one of a vocoder and a voice decoder.

45. The apparatus of claim 44, wherein the predetermined assignment of each n-bit symbol to the human vocal sound includes a selection of the human vocal sound to maximize a Hamming distance between a first vocoder output bit representation of the human vocal sound and a second vocoder output bit representation of another human voice sound to which another of the n-bit symbols is assigned.

46. The apparatus of claim 44, wherein the data representing the human vocal sound is created using a human vocal tract model substantially similar to a human vocal tract model used by the vocoder.

47. The apparatus of claim 44, further comprising: a data source coupled to the in-band modem.

48. The apparatus of claim 44, further comprising: a vocoder coupled to the in-band modem.

49. The apparatus of claim 44, further comprising: a voice decoder coupled to the in-band modem.

50. The apparatus of claim 44, further comprising: a processor coupled to the in-band modem.

51. The apparatus of claim 44, further comprising: a cellular telephone transceiver coupled to the in-band modem.

52. A system comprising:
a processor;
a memory coupled to the processor;
an in-band modem coupled to the processor and configured to segment a data stream into one or more n-bit symbols; and
a data store coupled to the in-band modem, the data store configured to store a predetermined assignment of the n-bit symbol to a human vocal sound,
wherein the human vocal sound is configured to be passed through at least one of a vocoder and a voice decoder.
